(19) United States
(12) Patent Application Publication
(10) Pub. No.: US 2006/0209759 A1
(43) Pub. Date: Sep. 21, 2006

(54) Local mobility management in mobile Internet protocol network

(76) Inventor: Seppo Vesterinen, Oulunsalo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/361,355

(22) Filed: Feb. 24, 2006

(30) Foreign Application Priority Data
Feb. 24, 2005 (FI) 20055091

(51) Int. Cl. H04L 12/66

(52) U.S. Cl. 370/331; 370/352

(57) ABSTRACT

The invention relates to mobility management in a mobile Internet protocol network. The network comprises a local mobility domain access router and a wireless access point operationally connected to the local mobility domain router, where the wireless access point is proxying a mobile node. Data packets destined to the mobile node and entering the local mobility domain router hold a proxy care-of address assigned to the mobile node as a routing address. The proxy care-of address is replaced with a local address assigned to the wireless access point, where the local address is invisible to the mobile node. With the procedure of the invention, the local mobility domain router acts as a wireless attachment point for the mobile node, thus decreasing signalling over the air interface when the mobile node moves in the network.

### FIELD

The invention relates to communication methodologies in a mobile Internet protocol network, a local mobility domain router of a mobile Internet protocol network, a wireless access point of a mobile Internet protocol network, and computer programs for managing routing of data packets in the local mobility domain of a mobile Internet protocol network.

### BACKGROUND

High data rates enabled by third generation-based packet access technologies, such as HSDPA technology (High Speed Downlink Packet Access), and those beyond the third generation technologies provide great challenges to the management of mobility in mobile Internet protocol networks.

The mobility of mobile nodes results in a great number of handovers of the mobile nodes from one wireless access point to another while the data are required to flow uninterruptedly between a correspondent node and the mobile nodes, thus increasing signalling between the nodes of the Internet protocol network and signalling over an air interface between the wireless access point and the mobile nodes.

The signalling, however, results in a decrease in the performance of the mobile Internet protocol network and the air interface. It is useful to consider improvements in the local mobility management in a mobile Internet protocol network.

### BRIEF DESCRIPTION OF THE INVENTION

An object of the invention is to provide improved methods, an improved local mobility domain router, an improved wireless access point and improved computer programs.

According to a first aspect of the invention, there is provided a communication method in a mobile Internet protocol network, the method comprising: receiving, in a local mobility domain router, a data packet directed at a mobile node and assigned with the proxy care-of address of the mobile node; replacing the proxy care-of address with a local address of a wireless access point that is proxying the mobile node, the local address being terminated in the wireless access point; and forwarding the data packet to the wireless access point.

According to a second aspect of the invention, there is provided a communication method in a mobile Internet protocol network, the method comprising: receiving, in a wireless access point that is proxying a mobile node, a data packet directed at the mobile node and assigned with the local address of the wireless access point, the local address being terminated in the wireless access point; replacing the local address with a proxy care-of address of the mobile node; and forwarding the data packet to the mobile node by using the proxy care-of address.

According to a third aspect of the invention, there is provided a local mobility domain router for managing routing of data packets in a local mobility domain of a mobile Internet protocol network, the local mobility domain comprising at least one mobile node and at least one wireless access point operationally connected to the local mobility domain router, the local mobility domain router comprising: first receiving means for receiving a data packet directed at a mobile node and assigned with the proxy care-of address of the mobile node; first replacing means for replacing the proxy care-of address with a local address of a wireless access point that is proxying the mobile node, the local address being terminated in the wireless access point; and first forwarding means for forwarding the data packet to the wireless access point.

According to a fourth aspect of the invention, there is provided a wireless access point for providing wireless data services for at least one mobile node of a mobile Internet protocol network, the wireless access point being configured to proxy a mobile node and to hold a local address, the wireless access point comprising: second receiving means for receiving a data packet directed at the mobile node and assigned with the local address, the local address being terminated in the wireless access point; second replacing means for replacing the local address with a proxy care-of address of the mobile node; and second forwarding means for forwarding the data packet to the mobile node by using the proxy care-of address.

According to a fifth aspect of the invention, there is provided a computer program embodied on a computer readable medium, the computer program encoding instructions for executing a computer process for managing routing of data packets in a local mobility domain of a mobile Internet protocol network, the computer process comprising: receiving, in a local mobility domain router, a data packet directed at a mobile node and assigned with the proxy care-of address of the mobile node; replacing the proxy care-of address with a local address of a wireless access point that is proxying the mobile node, the local address being terminated in the wireless access point; and forwarding the data packet to the wireless access point.

According to another aspect of the invention, there is provided a computer program embodied on a computer readable medium, the computer program encoding instructions for executing a computer process for managing routing of data packets in a local mobility domain of a mobile Internet protocol network, the computer process comprising: receiving, in a wireless access point that is proxying a mobile node, a data packet directed at the mobile node and assigned with the local address of the wireless access point, the local address being terminated in the wireless access point; replacing the local address with a proxy care-of address of the mobile node; and forwarding the data packet to the mobile node by using the proxy care-of address.

The invention provides several advantages.

In an embodiment of the invention, the invention reduces signalling overhead between a wireless access point and a mobile node, thus increasing the performance of radio interface between the infrastructure of the mobile Internet protocol network and the mobile node.

### LIST OF DRAWINGS

In the following, the invention will be described in greater detail with reference to embodiments and the accompanying drawings, in which

FIG. 1 shows an example of the structure of a mobile Internet protocol network;

FIG. 2 illustrates a first example of a local mobility domain router;

FIG. 3 illustrates a second example of a local mobility domain router;

FIG. 4 illustrates a first example of a wireless access point;

FIG. 5 illustrates a second example of a wireless access point;

FIG. 6 shows a first example of a methodology according to an embodiment of the invention; and

FIG. 7 shows a second example of a methodology according to an embodiment of the invention.

### DESCRIPTION OF EMBODIMENTS

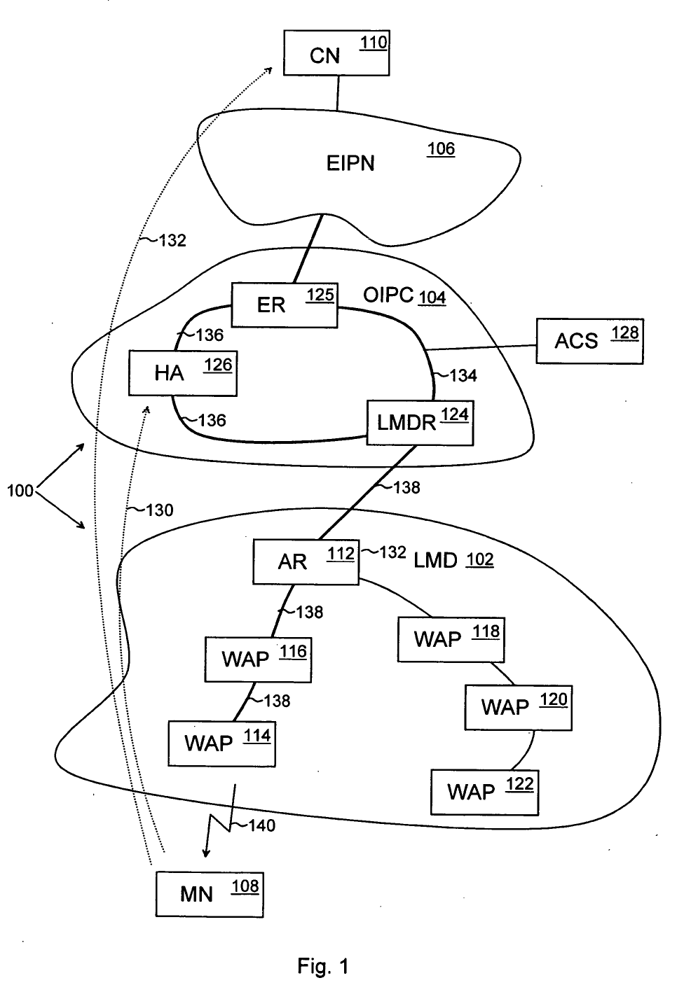

With reference to FIG. 1, examine an example of a mobile Internet protocol network 100 to which embodiments of the invention can be applied.

The mobile Internet protocol (IP) network 100 comprises a local mobility domain (LMD) 102 for providing local mobility for a mobile node 108 within the local mobility domain 102. The mobile IP network 100 is connected to an external Internet protocol network (EIPN) 106, and further to a correspondent node (CN) 110 via the external IP network 106.

The local mobility enables movement of the mobile node 108, without requiring a change to its routable IP address seen by the correspondent node 110 or a home agent 126. Although its point of attachment may change during the movement, IP addresses, such as a mobile node home address and an IP subnet routable IP address used for reaching the mobile node 108 do not change. In this context, the mobile mobility and the mobile IP network 100 may also be called a wireless mobility and wireless mobile IP network, respectively.

In an embodiment of the invention, the mobile IP network 100 supports a mobile Internet protocol version 6 (MIPv6).

The mobile Internet protocol network 100 further comprises an operator's Internet protocol core (OIPC) 104, which acts as a backbone of the operator's mobile Internet protocol services.

In an embodiment of the invention, the operator's IP core 104 includes an edge router (ER) 125 for routing data packets between the external IP network 106 and the mobile IP network 100.

The operator's IP core 104 may further be connected to an access control server (ACS) 128.

The mobile IP network 100 further includes a local mobility domain router 124, which manages the routing of data packets in the local mobility domain 102. The local mobility domain 102 and the local mobility domain router 124 may also be called an access server network (ASN) and an access server gateway (ASNGW), respectively. The local mobility domain router 124 may also be called a local mobility agent and/or an area border router. In an embodiment of the invention, the present solution is applied to a WiMax based network (Worldwide interoperability for Microwave Access).

The local mobility domain router 124 typically comprises a digital computer for executing computer processes, and memory for storing computer program codes.

In an embodiment of the invention, the mobile IP network 100 further includes a home agent (HA) 126, which is a router on a mobile node's 108 home link in which the mobile node 108 may registered its proxy care-of address. The registration of the proxy care-of address may be implemented with basic mobile registration protocol, which may be in accordance, for example, with a MIPv6 (Mobility Internet Protocol version 6) or MIPv4 (Mobility Internet Protocol version 4). A registration signal 130 from the mobile node 108 to the home agent 126 is shown with a dotted line.

In an embodiment of the invention, the home agent 126 intercepts packets originating from the correspondent node 110 and destined to the mobile node's 108 home address (MNHA), encapsulates the data packets by using the proxy care-of address, and tunnels the data packet to the mobile node's 108 registered proxy care-of address (PCoA). The route of the data packet from the edge router 125 to the local mobility domain router 124 is illustrated with reference numeral 136.

In another embodiment of the invention, the mobile node 108 carries out a correspondent registration with the correspondent node 110 and signals a binding update message 132 illustrated with a dotted line to the correspondent node 110.

The binding update message 132 includes binding information for associating the mobile node's 108 home address with the proxy care-of address in the correspondent node 110.

In such a case, the data packet from the correspondent node 110 is addressed to the mobile node 108 with the proxy care-of address, while the mobile node's 108 home address is used as a routing header. The data packet is delivered directly from the edge router 125 to the local mobility domain router 124, and the data packet is not required to be delivered to the home agent 126. In this case, the route between the edge router 125 and the local mobility domain router 124 is illustrated with reference numeral 124. The use of the proxy care-of address in the correspondent node 110 is also called a routing optimisation, as the home agent 126 is not required in the routing.

The proxy care-of address is an IP address associated with a mobile node 108 while visiting a foreign link. The subnet prefix of this IP address is a typically a foreign subnet prefix. A packet addressed to the mobile node 108 and arriving at the mobile node's 108 home network when the mobile node 108 is located in a visiting local mobility domain and has registered a proxy care-of address may be forwarded to that address in the operator's IP core 104.

In an embodiment of the invention, the proxy care-of address is based on a local mobility domain router prefix and mobile node's interface identity portion of the IPv6 address associated with the local address of the wireless access point 114.

The mobile node 108 is an IP node capable of attaching wirelessly to a wireless access point (WAP) 114, 116, 118, 120, 122 and changing its wireless point of attachment to the mobile IP network 100. The mobile node may 108 also be called user equipment, a mobile station, a mobile terminal, and/or a mobile subscriber station.

A wireless access point 114 to 122 is a network element which is connected to one or more access routers 112 and provides the mobile node 108 with a wireless connectivity. A wireless access point 114 to 122 may also be called a base station and/or a base transceiver station. A wireless access point 114 to 122 may be a separate entity or co-located with the access router 112. The wireless access points 114 to 122 may further be concatenated with each other.

The wireless access point 114 to 122 typically comprises a digital computer for executing computer processes, and memory for storing computer program codes.

A wireless link between the mobile node 108 and the infrastructure of the mobile IP network 100 may be implemented with known radio access technologies such as those described in 3GPP (3^{rd} Generation Partnership Project) or other radio access technologies enabling high data rates over the wireless link. In an embodiment of the invention, the wireless link is implemented with a technology applied to a 3.9G and/or 4G radio interface.

The access router (AR) 112 provides a gateway between the local mobility domain router 124 and the wireless access points 114 to 122. The access router 112 typically offers IP connectivity to the mobile node 108, acting as a next hop router to the mobile node 108 it is currently serving. The access router 112 may further include intelligence beyond a simple forwarding service provided by ordinary IP routers.

In an aspect of the invention, the wireless access point 114 is proxying the mobile node 108, and the wireless access point 114 holds a local address that is used for addressing data packets from the local mobility domain router 124 to the wireless access point 114. The local address terminates at the wireless access point 114, that is, the local address is invisible to the mobile node 108. From the viewpoint of the mobile node 108, the proxy function of the wireless access point 114 results in that the mobile node 108 being virtually attached to the local mobility domain router 124 instead of the wireless access point 114.

The local address, also called a local care-of address and/or on-link care-of address may be based on on-link access router prefix and mobile node's interface identity portion of the Ipv6 address.

The local mobility domain router 124 receives a data packet directed at the mobile node 108. The data packet is assigned with the proxy care-of address assigned to the mobile node 108. The local mobility domain router 124 typically acts as a default router for the mobile node 108, which results from the proxy nature of the wireless access point 114 with respect to the mobile node 108.

The local mobility domain router 124 replaces the proxy care-of address with the local address of the wireless access point 114 and forwards the data packet to the wireless access point 114 by using the local address. In this case, the route between the local mobility domain router 124 and the wireless access point is indicated with reference numeral 138.

The wireless access point 114 receives the data packet, replaces the local address with the proxy care-of address of the mobile node 108 and forwards the data packet to the mobile node 108 by using the proxy care-of address over a wireless telecommunication signal 140.

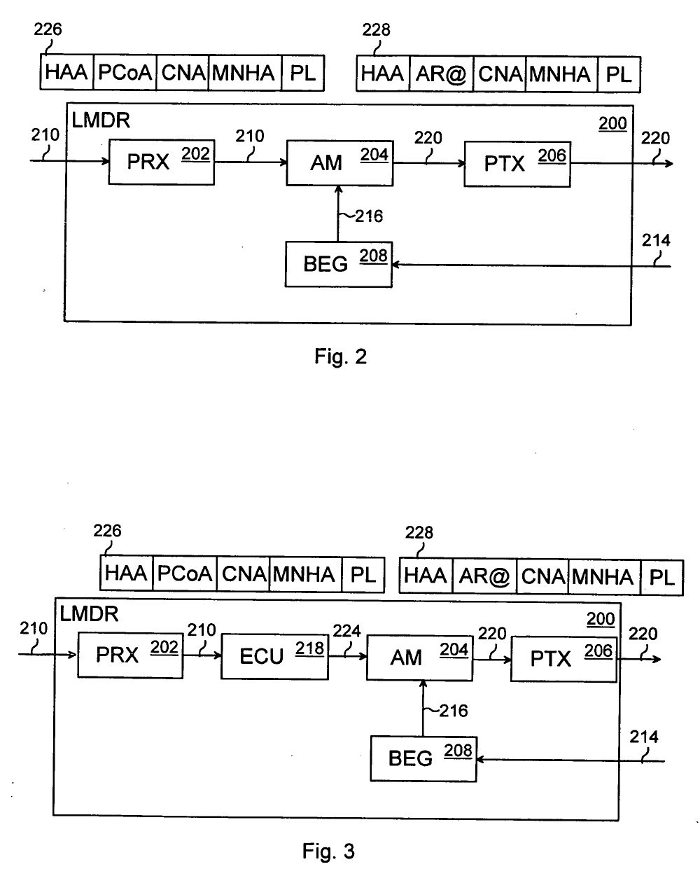

With reference to FIG. 2, a local mobility domain router 200 comprises a packet receiver (PRX) 202, an address manager (AM) 204 connected to the packet receiver 202, and a packet transmitter (PTX) 206 connected to the address manager 204.

The packet receiver 202 receives a data packet 210 from the edge router 125 or from the home agent 126, and forwards the data packet 210 to the address manager 204.

The format of the data packet 210 when entering the address manager 204 is illustrated with a frame structure 226, which includes a home agent address (HAA), a proxy care-of address (PCOA) of the mobile node 108, a correspondent node address (CNA) of the correspondent node 110, the mobile node's 108 home address (MNHA), and a payload bit stream (PL) of the data packet 210.

The address manager 204 replaces the proxy care-of address (PCOA) with the local address (AR@) assigned to the wireless access point 114 that is proxying the mobile node 108. The data packet 220 exiting the address manager is exemplified with a frame structure 228, which includes the HAA, AR@, CNA, and the PL.

The address manager 204 delivers the data packet 220 to a packet transmitter (PTX), which forwards the data packet 220 to the wireless access point 114.

In an embodiment of the invention, the local mobility domain router 200 comprises a binding entry generator 208 for creating a binding cache entry for the home address and the proxy care-of address of the mobile node 108 and for the local address of the wireless access point 114 as a response to a control message 214 received from the wireless access point 114.

Typically, the control message 214 is in accordance with an ICMP (Internet Control Message Protocol), thus including proxy binding update information, the mobile node's home address, the proxy care-of address, and the local address.

An information signal 216 including information on the binding cache entry may be delivered to the address manager 204, based on which information the address manager 204 may modify address fields of the data packet 210.

The local mobility domain router 200 may send an acknowledgement message to the wireless access point as an indication of a successful binding cache entry creation.

The binding cache entry is used for making appropriate associations between the proxy care-of address, local address and the mobile node's home address.

With reference to FIG. 3, the local mobility domain router 200 may further include an encapsulating unit 218 for encapsulating an Ipv4 data packet into an Ipv6 data packet. The encapsulating unit 218 receives an Ipv4 data packet 210 from the packet receiver 202, encapsulates the Ipv4 data packet into the Ipv6 data packet 224, and delivers the Ipv6 data packet 224 to the address manager 204. The encapsulation functionality enables the MIPv6 network to be used for mobile nodes that support Ipv4, but do not support MIPv6.

The address manager 204 may be implemented with a computer program executed in a digital processor of the local mobility domain router 200.

The packet receiver 202 may be implemented with a computer program executed in a digital processor of the local mobility domain router 200. The packet receiver 202 may further include buses, buffers and connectors.

The packet transmitter 206 may be implemented with a computer program executed in a digital processor of the local mobility domain router 200. The packet transmitter 206 may further include buses, buffers and connectors.

The binding entry generator 208 may be implemented with a computer program executed in a digital processor of the local mobility domain router 200.

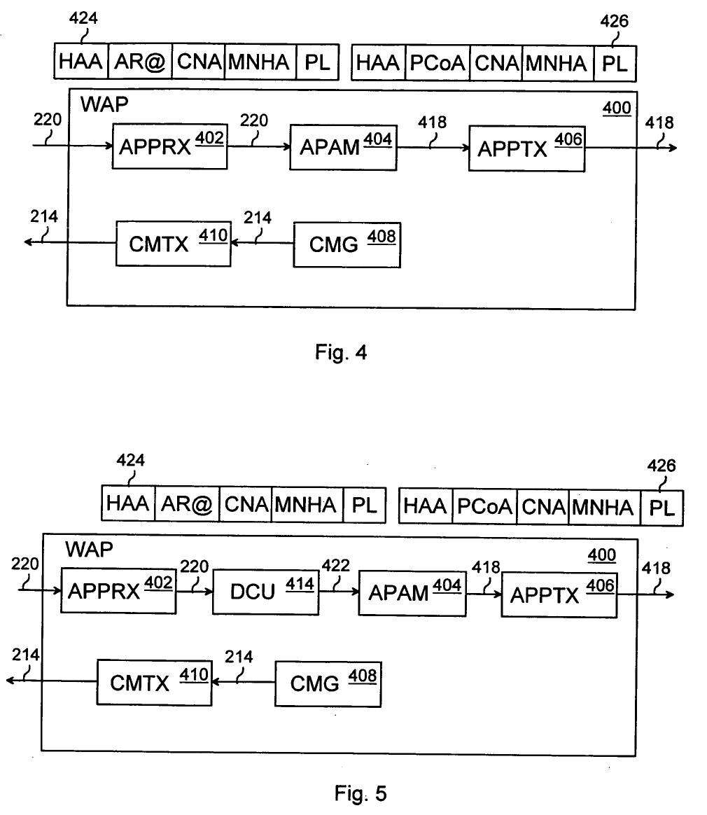

With reference to FIG. 4, a wireless access point 400 includes an access point packet receiver (APPRX) 402, an access point address manager (APAM) 404, and an access point packet transmitter (APPTX) 406.

The access point packet receiver 402 receives the data packet 220 directed at the mobile node 108.

The access point packet receiver 402 delivers the data packet to the access point address manager 404.

The format of the data packet 220 when entering the access point address manager 404 is illustrated with a frame structure 424, which includes the home agent address (HAA), the local address (AR@) assigned to the wireless access point 114 that is proxying the mobile node 108, the correspondent node address (CNA) of the correspondent node 110, the mobile node's 108 home address (MNHA), and the payload bit stream (PL) of the data packet 220.

The access point address manager 404 replaces the local address (AR@) with a proxy care-of address (PCoA) of the mobile node 108. Such a replacement may also be called address swapping.

The format of the data packet when exiting the access point address manager 404 is exemplified with a frame structure 426, which includes the HAA, PCoA, CNA, and PL.

The access point address manager 404 outputs the data packet 418 to the access point packet transmitter 406, which forwards the data packet 418 to the mobile node 108.

In an embodiment of the invention, the wireless access point 400 comprises a control message generator (CMG) 408 for generating a control message 214. The control message 214 is inputted into a control message transmitter 410, which transmits the control message 214 to the local mobility domain router 124, 200.

In a radio handover situation, i.e. when the mobile node 108 changes the wireless access point, let us say, from the wireless access point 114 to a next wireless access point 122, the next wireless access point 122 generates a control message and transmits the control message to the local mobility domain router 124. In such a case, the control message includes the local address of the next wireless access point 122 in the proxy binding update information.

The local mobility domain router 124 creates the binding cache entry according to updated proxy binding information, and forwards the data packets to the next wireless access point 122. In this procedure, the proxy care-of address and the mobile node's home address assigned to the mobile node 108 remain unaltered, and no associated signaling over the air interface is required. Furthermore, as a result of the invisibility of the local address to the mobile node 108, the radio handover does not involve IP related signaling over the air interface.

With reference to FIG. 5, the wireless access point 400 may comprise a decapsulating unit 414, which decapsulates an IPv6 packet 220 into an IPv4 packet 422.

The decapsulating unit 414 receives the IPv6 data packet 220 from the access point packet receiver 402, decapsulates the Ipv6 data packet into the IPv4 data packet 422, and delivers the IPv4 data packet 422 to the access point address manager 404. The decapsulation functionality enables the MIPv6 network to be used for mobile nodes that support IPv4, but do not support MIPv6.

The access point address manager 404 may be implemented with a computer program executed in a digital processor of the wireless access point 400.

The access point packet receiver 402 may be implemented with a computer program executed in the digital processor of the wireless access point 400. The access point packet receiver 402 may further include buses, buffers and connectors.

The access point packet transmitter 406 may be implemented with a computer program executed in the digital processor of the wireless access point 400. The access point packet transmitter 406 may further include buses, buffers and connectors.

The decapsulating unit 414 may be implemented with a computer program executed in the digital processor of the wireless access point 400.

The control message generator 408 may be implemented with a computer program executed in the digital processor of the wireless access point 400.

The control message transmitter 408 may be implemented with a computer program executed in the digital processor of the wireless access point 400. The control message transmitter 410 may further include buses, buffers and connectors.

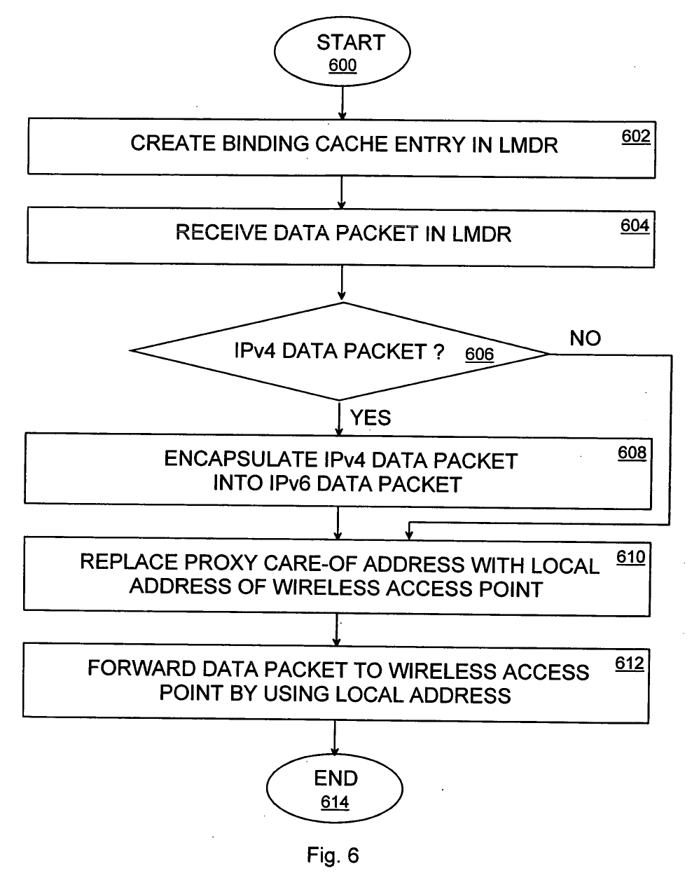

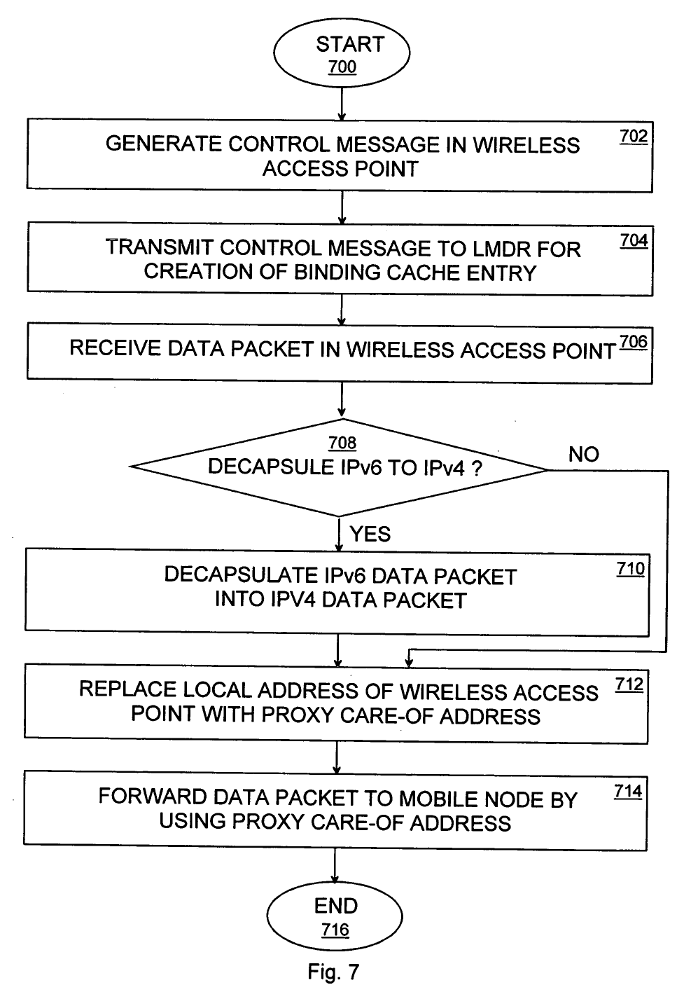

With reference to FIGS. 6 and 7, methodologies according to embodiments of the invention are shown with flow chart presentations. The flow chart in FIG. 6 relates to a methodology implemented by the local mobility domain router 124, 200, whereas FIG. 7 relates to a methodology implemented in the wireless access point 114, 400.

With reference to FIG. 6, the method starts in 600.

In 602, a binding cache entry for the home address and the proxy care-of address of the mobile node and for the local address of the wireless access point are created in the local mobility domain router 124, 200 as a response to a control message 214 received from the wireless access point 114 and generated in the wireless access point 114.

In 604, a data packet 210 directed at a mobile node 108 and assigned with the proxy care-of address of the mobile node 108 is received in the local mobility domain router 124, 200.

If 606, the data packet 210 is an IPv4 data packet, the data packet 210 is encapsulated into IPv6 data packet in 608.

In 610, the proxy care-of address assigned to the mobile node 108 is replaced with a local address of a wireless access point 114 that is proxying the mobile node 108, the local address being terminated at the wireless access point 114.

In 612, the data packet is forwarded to the wireless access point 114.

In 614, the method ends.

With reference to FIG. 7, the method starts in 700.

In 702, a control message 214 is generated in the wireless access point 114.

In 704, the control message 214 is transmitted to the local mobility domain router for creation of a binding cache entry for the home address and the proxy care-of address of the mobile node 108 and for the local address of the wireless access point 114 as a response to the control message 214.

In 706, the data packet 220 directed at the mobile node 108 and assigned with the local address of the wireless access point 114, the local address being terminated in the wireless access point, is received in the wireless access point 114 that is proxying the mobile node 108.

If 708 the data packet 220 is required to be reformatted from an IPv6 format to an IPv4 format, the IPv6 data packet 220 is decapsulated into an IPv4 data packet 422 in 710.

In 712, the local address assigned to the wireless access point 114 is replaced with a proxy care-of address of the mobile node 108.

In 714, the data packet is forwarded to the mobile node 108 by using the proxy care-of address.

In 716, the method ends.

In an aspect, the invention provides computer programs embodied on a computer readable medium, the computer programs encoding instructions for executing a computer processes for managing the routing of data packets in the local mobility domain 102 of the mobile IP network 100.

The local mobility domain router 124, 200 may be configured to perform at least some of the steps described in connection with the flowchart of FIG. 6 and in connection with FIGS. 1, 2, and 3. The computer program may be executed in the digital processor and stored in the memory unit of the local mobility domain router 124, 200.

The wireless access point 114, 400 may be configured to perform at least some of the steps described in connection with the flowchart of FIG. 7 and in connection with FIGS. 1, 4, and 5. The computer program may be executed in the digital processor and stored in the memory unit of the wireless access point 114, 400.

The computer program may further be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention has been described above with reference to examples according to the accompanying drawings, it is clear that the invention is not restricted thereto but the invention can be modified in several ways within the scope of the appended claims.

1. A communication method in a mobile Internet protocol network, comprising:
receiving, in a local mobility domain router, a data packet directed at a mobile node and assigned with a proxy care-of address of the mobile node;
replacing the proxy care-of address with a local address of a wireless access point that is providing proxy services for the mobile node, the local address being terminated in the wireless access point; and
forwarding the data packet to the wireless access point.

2. The method of claim 1, wherein the step of receiving the data packet in the local mobility domain router comprises receiving an Internet protocol version 4 data packet, the method further comprising encapsulating the data packet into an Internet protocol version 6 data packet.

3. The method of claim 1, further comprising creating, in the local mobility domain router, a binding cache entry for a home address and the proxy care-of address of the mobile node and for the local address of the wireless access point as a response to a control message received from the wireless access point and generated in the wireless access point.

4. A communication method in a mobile Internet protocol network, comprising:
receiving, in a wireless access point that is providing proxy services for a mobile node, a data packet directed at the mobile node and assigned with the local address of the wireless access point, the local address being terminated in the wireless access point;
replacing the local address with a proxy care-of address of the mobile node; and
forwarding the data packet to the mobile node by using the proxy care-of address.

5. The method of claim 4, wherein the step of receiving the data packet in the wireless access point comprises receiving an Internet protocol version 6 data packet including an encapsulated Internet protocol version 4 data packet, the method further comprising decapsulating the data packet into an Internet protocol version 4 data packet.

6. The method of claim 4, further comprising:
generating a control message in the wireless access point; and
transmitting the control message to a local mobility domain router for creation of a binding cache entry for a home address and the proxy care-of address of the mobile node and for the local address of the wireless access point as a response to the control message.

7. A local mobility domain router for managing routing of data packets in a local mobility domain of a mobile Internet protocol network, the local mobility domain comprising at least one mobile node and at least one wireless access point operationally connected to the local mobility domain router, the local mobility domain router comprising:
receiving means for receiving a data packet directed at a mobile node and assigned with a proxy care-of address of the mobile node;
replacing means for replacing the proxy care-of address with a local address of a wireless access point that is proxying the mobile node, the local address being terminated in the wireless access point; and
forwarding means for forwarding the data packet to the wireless access point.

8. The local mobility domain router of claim 7, wherein the data packet is an Internet protocol version 4 data packet and the local mobility domain router further comprises encapsulating means for encapsulating the data packet into an Internet protocol version 6 data packet.

9. The local mobility domain router of claim 7, further comprising creating means for creating a binding cache entry for a home address and the proxy care-of address of the mobile node and for the local address of the wireless access point as a response to a control message received from the wireless access point.

10. A wireless access point for providing wireless data services for at least one mobile node of a mobile Internet protocol network, the wireless access point being configured to provide proxy services for a mobile node and to hold a local address, the wireless access point comprising:
receiving means for receiving a data packet directed at the mobile node and assigned with the local address, the local address being terminated in the wireless access point;
replacing means for replacing the local address with a proxy care-of address of the mobile node; and
forwarding means for forwarding the data packet to the mobile node by using the proxy care-of address.

11. A wireless access point of claim 10, wherein the data packet is an Internet protocol version 6 data packet and the wireless access point further comprises decapsulating means for decapsulating the data packet into an Internet protocol version 4 data packet.

12. A wireless access point of claim 10, further comprising:
generating means for generating a control message; and
transmitting means for transmitting the control message to a local mobility domain router for creation of a binding cache entry for a home address and the proxy care-of address of the mobile node and for the local address of the wireless access point as a response to the control message.

13. A computer program embodied on a computer readable medium, the computer program encoding instructions for executing a computer process for managing routing of data packets in a local mobility domain of a mobile Internet protocol network, the computer process comprising:
receiving, in a local mobility domain router, a data packet directed at a mobile node and assigned with a proxy care-of address of the mobile node;
replacing the proxy care-of address with a local address of a wireless access point that is providing proxy services for the mobile node, the local address being terminated in the wireless access point; and
forwarding the data packet to the wireless access point.

14. A computer program embodied on a computer readable medium, the computer program encoding instructions for executing a computer process for managing routing of data packets in a local mobility domain of a mobile Internet protocol network, the computer process comprising:
receiving, in a wireless access point that is providing proxy services for a mobile node, a data packet directed at the mobile node and assigned with a local address of the wireless access point, the local address being terminated in the wireless access point;
replacing the local address with a proxy care-of address of the mobile node; and
forwarding the data packet to the mobile node by using the proxy care-of address.
